(19) United States
(12) Patent Application Publication
(10) Pub. No.: US 2013/0141397 A1
(43) Pub. Date: Jun. 6, 2013

(54) STYLUS DEVICE FOR TOUCH SCREEN

(71) Applicant: Kelly Allan Dunagan, La Habra, CA (US)

(72) Inventor: Kelly Allan Dunagan, La Habra, CA (US)

(21) Appl. No.: 13/312,502

(22) Filed: Dec. 6, 2011

(51) Int. Cl. G06F 3/033

(52) U.S. Cl. 345/179

(57) ABSTRACT

A stylus device for writing or drawing on a touch screen has an elongate barrel for gripping by a user and a stylus tip of rigid, non-compressible material secured to one end of the barrel and having an end face comprising a working surface configured for contact with the touch screen while writing or drawing. The stylus tip is oriented at a predetermined offset angle to the longitudinal axis of the barrel, such that the working surface is not perpendicular to the central longitudinal axis of the barrel. The working surface is applied to a touch screen to develop a contact patch between the working surface and screen sufficient to trigger an input on the screen.

### BACKGROUND

1. Field of the Invention

The present invention generally relates to a stylus or pen-like device used to input commands, hand written text or drawings on a touch screen of devices such as cell phones, personal digital assistants, video games, computers, and the like, and is particularly concerned with a tip for a touch screen stylus.

2. Related Art

Touch screen panels detect touching of the screen surface by a user's finger or a stylus to enable entry of commands. A stylus is generally required for writing or drawing on such panels, but existing devices are not sufficiently accurate for technical drawing, and also do not provide good feel or feedback for writing or drawing. There are several types of touch screen device, including resistive and capacitive touch screens. Resistive touch screens have two metal layers separated by a narrow gap. Touching the screen with a finger or writing instrument causes the layers to come into contact at the point where the screen is touched, which is registered as an input by the controller. A capacitive touch screen has an insulative layer such as glass coated with a transparent conductive layer. Touching the surface of the screen with a finger or with a conductive stylus results in a distortion of the screen's electrostatic field, and the resultant change in capacitance is detected as an input by the controller.

Known stylus devices or drawing instruments for input of information onto capacitive or resistive touch screen devices have a conductive pen-like handle or holder, with a tip at the end of the handle having an interface portion for touching the screen. In some cases, the user's view of the screen is limited by the handle. Holding of the stylus stem or barrel can also be awkward where the tip is aligned with the handle axis, since the handle cannot be kept at the natural angle of attack of traditional writing instruments to the writing surface while keeping the tip at the proper angle of engagement to the screen.

### SUMMARY

Embodiments described herein provide for a stylus device configured for more convenient writing or drawing on a capacitive touch screen.

In one aspect, a writing or drawing stylus device is provided for use on a capacitive touch screen has a rigid stylus tip of non-compressible material having an end face configured for contact with the capacitive touch screen while writing or drawing, and an elongate barrel configured for gripping by a user and having a first end secured to the rigid stylus tip. The stylus tip extends at an offset angle to the barrel and the end face or working surface is not perpendicular to the central longitudinal axis of the barrel.

In one embodiment, the barrel and tip are formed integrally while in other embodiments the stylus tip is a separate modular part which is releasably or permanently secured to the end of the barrel. Where the stylus tip is formed separately from the barrel, the tip has a connector portion or shaft for co-axial connection to the barrel and a head or tip including the end face or working surface which extends at an offset angle to the connector portion or shaft. In one embodiment, the offset angle is in the range from 1 to 30 degrees. This offset allows the barrel of the writing instrument or stylus device to be held at a more natural angle of attack similar to conventional writing instruments, while keeping the tip at normal operating angles to the writing surface.

The stylus tip in one embodiment has a screen interface or working surface which has a cross-sectional shape which is an arc or curve of predetermined radius, a hyperbola, or an ellipse. The slight curvature allows the working surface to maintain contact with the capacitive screen while the stylus device pivots and yaws during use. In an alternative embodiment, the end face may be flat.

The tip may have an undercut immediately behind the working surface or interface. This provides an expanded field of vision for the user, allowing for a better view of the immediate activity at the screen through removal of obstructing material from the rear side of the interface surface. The interface surface may also have a blend radius at its outer periphery between the interface surface and undercut region, avoiding any sharp edges which may damage the screen. The interface surface has a circular periphery in one embodiment. The dimensions of the interface surface are selected to provide sufficient surface area for capacitive activity.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a perspective view of one embodiment of a touch screen stylus device;

FIG. 2 is an enlarged side elevation view of the stylus tip or head of the device of FIG. 1;

FIG. 3 is a perspective view of the enlarged stylus tip of FIG. 2;

FIG. 4 is a top plan view of the enlarged stylus tip similar to FIGS. 2 and 3 but illustrating a modification in dotted outline in which the stylus tip is configured for releasable connection to a barrel or handle;

FIG. 5 is a front elevation view of the stylus device of FIGS. 1 to 4;

FIG. 6 is a rear end elevation view of the stylus device of FIGS. 1 to 5;

FIG. 7 is a left side elevation view of the stylus device of FIGS. 1 to 6;

FIG. 8 is a right side elevation view of the stylus device of FIGS. 1 to 7;

FIG. 9 is a bottom plan view of the stylus device of FIGS. 1 to 8; and

FIG. 10 is a top plan view of the stylus device of FIGS. 1 to 9.

### DETAILED DESCRIPTION

Certain embodiments as disclosed herein provide for a stylus device having a tip for writing or drawing on touch screens such as capacitive touch screen of cell phones, personal digital assistants, video games, computers, and the like.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention.

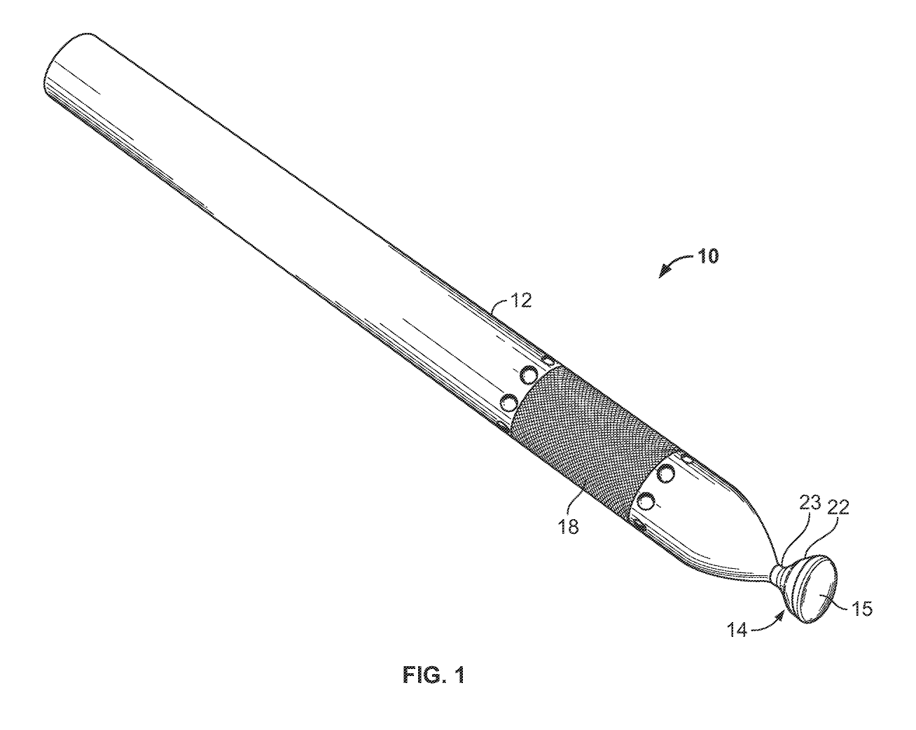

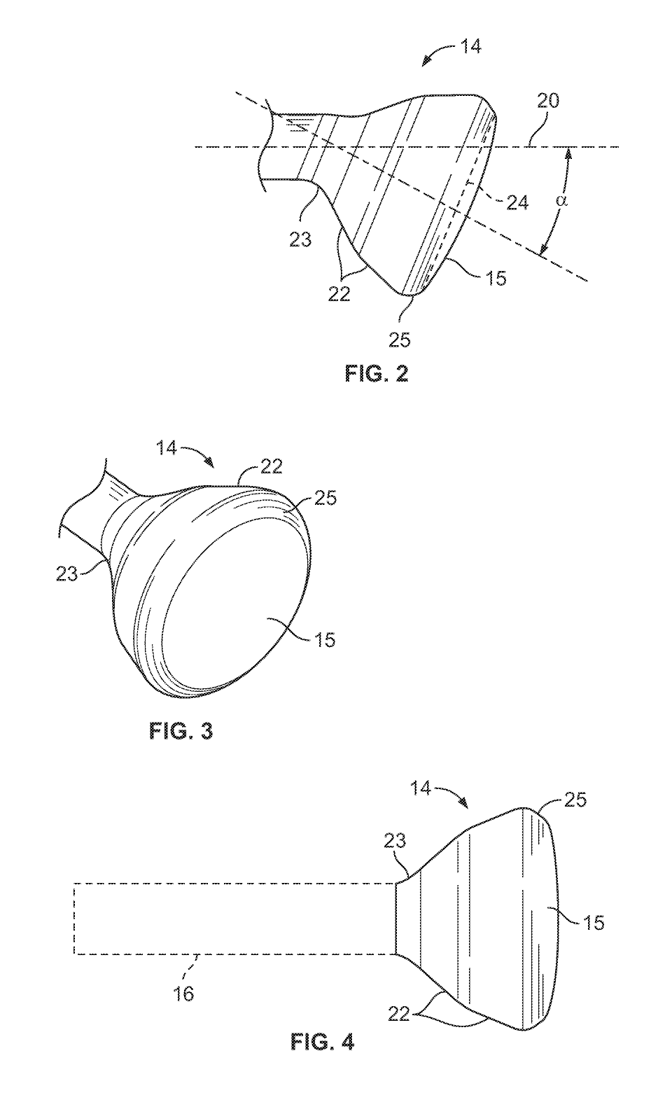

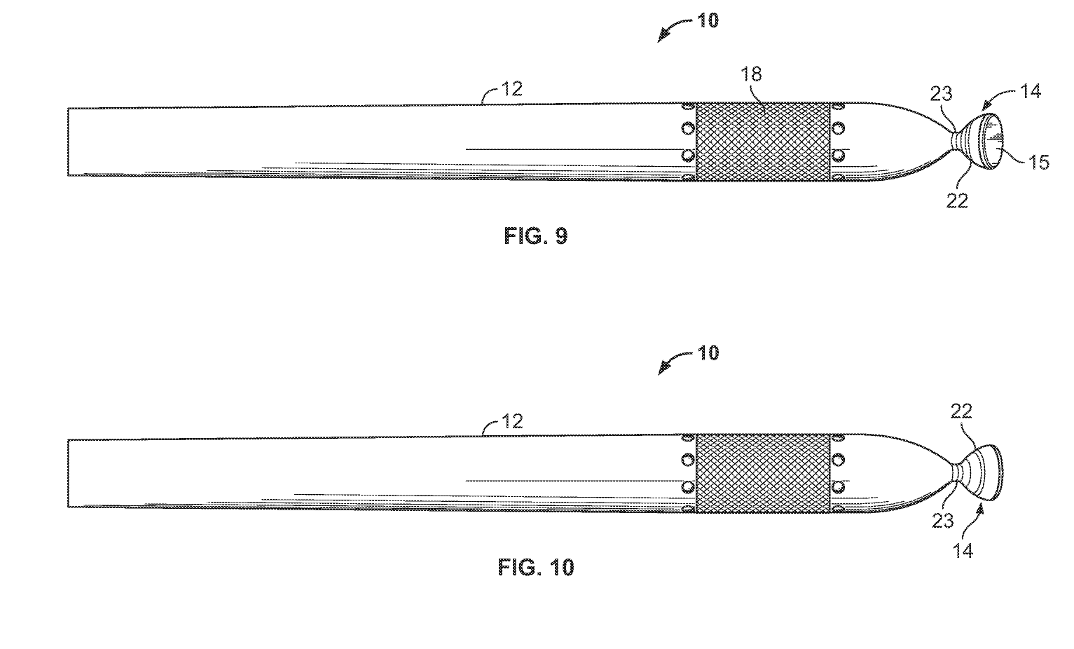

FIGS. 1 to 10 illustrate one embodiment of a stylus tip device 10 which has a pen or pencil-like elongate body or barrel 12 for gripping by a user and a head or stylus tip 14 having an interface or working surface or end face 15 configured for engagement with a capacitive screen. As illustrated in FIGS. 1 and 7 to 10, the barrel 12 is of elongate, generally cylindrical shape with a non-smooth gripping portion 18, and has a central longitudinal axis 20, as illustrated in FIGS. 2 and 7. The stylus tip 14 is oriented at an offset angle α to the axis 20 of the barrel, as best illustrated in FIGS. 1, 2 and 5 to 9. This means that the working or interface surface 15 is not perpendicular to the barrel axis as is the case with most stylus devices. The offset angle may be in the range from one degree to thirty degrees, and is around 15 to 25 degrees in the illustrated embodiment. The resultant offset writing angle allows the barrel 12 to be held at a natural angle of attack similar to normal writing instruments, while keeping the tip or working surface 15 at a normal operating angle relative to the normally non-horizontal writing surface of a touch screen.

FIGS. 2 and 3 are enlarged views of one embodiment of stylus tip 14 to illustrate its shape in more detail. In the illustrated embodiment, the head or stylus tip 14 is formed integrally with barrel 12, but it may alternatively be formed separately with a connector portion or shaft 16 as illustrated in dotted outline in FIG. 4. In this alternative embodiment, connector portion 16 is configured for coaxial attachment to a barrel, and the tip 14 extends at the selected offset angle to connector portion or shaft 16. Shaft 16 may be of any suitable shapes and dimensions for attachment to a standard barrel or stylus with interchangable stylus tips. Shaft 16 may have a threaded attachment end for engagement with a corresponding threaded end of a pen or pencil-like, hand held stylus or barrel, or may be used as the nib or “lead” for other types of writing and drawing instruments in alternative embodiments. The stylus tip 14 in FIG. 4 is otherwise identical to that of FIGS. 2 and 3, and like reference numbers are used for like parts as appropriate.

Stylus tip 14 is made from a hard, non-compressible conductive material which may be conductive metal, impregnated plastics or resins, ceramics, compacted fiber or the like, and may be uncoated or coated with conductive or semi-conductive material. Tip or head 14 may alternatively be formed of a hard, non-compressible non-conductive material coated with a conductive or semi-conductive coating. The stylus tip is used to trigger the capacitive discharge element in touch screen devices.

The barrel may also be of metal or other hard, non-compressible material, and in one embodiment barrel 12 is of the same material as stylus tip 14. In one embodiment, the stylus tip may be coated with a suitable material while the remainder of the barrel is uncoated. The durable nature of the non-compressible materials used for the stylus device translate into a durable product which is more resistant to the elements and to wear in everyday use, producing a longer product lifetime.

An undercut 22 is provided immediately behind the working or interface surface 15, removing obstructing material from the area behind the writing surface. The undercut 22 is of progressively reducing diameter up to neck 23 at the interface between stylus tip 14 and handle or barrel 12. The undercut 22 together with the offset angle together help to provide a greater viewing field for the user at the actual point of interaction between the interface surface 15 at the tip and the screen. Additionally, the design shape of the stylus tip allows for development of a smaller overall footprint for the tip.

The interface or working surface 15 of the tip in the illustrated embodiment has a curved or arcuate cross-section, and has a selected interface radius R and a chord 24 of selected chord length C to provide sufficient interface radius surface area for capacitive activity. The surface 15 may be of part spherical shape or may be of other part spheroidal shapes such as ellipsoidal, parabolic hyperboloidal, or other regular or irregular curved shapes, and in these cases a three point curve fit approximation value for the radius is used. Where the interface surface is non-flat, the ratio of the interface radius chord length to the interface radius (i.e. C/R) is less than two. In one example of a tip for cursive applications, the interface radius was around 0.60 inches with a chord length of arround 0.23 inches. In an example for drafting and drawing purposes, an interface radius of up to 5.00 inches with a chord length of around 0.15 inches may be used. In one example, the smallest interface radius was around 0.25 inches with a chord length of 0.50 inches. The interface radius may be in the range from about 0.25 to 5.00 inches. The size of the radius affects the chord length. Where the interface radius is zero (a flat surface), the minimum diameter of the flat working surface is approximately 0.14 inches, and the surface area of the interface or contact patch formed by contact of the working surface with the screen is in a range from 0.12 to 0.07 square inches (in²), which is sufficient to trigger an input on the screen. The slightly curved working surface 15 of the tip allows the tip to maintain sufficient approximation to, and contact with, the capacitive screen while the stylus device 10 pivots and yaws during use.

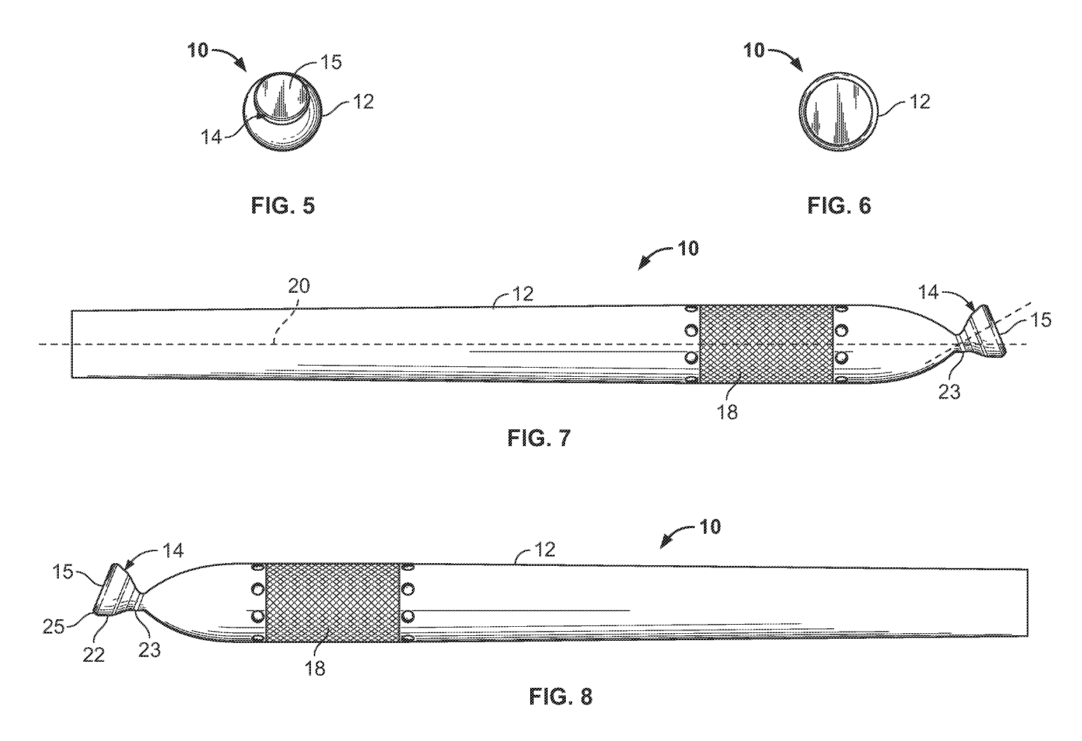

As illustrated in FIG. 5, the surface 15 of the tip has a circular periphery or outer diameter, but may be of other peripheral shapes in alternative embodiments. In the illustrated embodiment, the tip has a blend radius or rounded edge 25 leading to the outer diameter to provide a rounded edge to prevent damage to the touch screen and also to minimize the outer diameter.

The stylus device described above may have an integral stylus tip or a detachable stylus tip, and in either case the tip is at an offset angle to the central longitudinal axis of the barrel and also has an undercut immediately behind the working surface, with both of these features providing for a greater viewing field at the actual point of interaction with the screen and thus greater accuracy of placement of the working surface or end of the tip on the screen. The tip is made of a durable, hard and incompressible material which results in extended lifetime and reduced wear in use. The slightly curvature or radius of the working surface helps to maintain contact with the capacitive screen while the writing instrument pivots and yaws during use.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A stylus device for use on a capacitive touch screen, comprising:
a stylus tip of rigid, non-compressible material having an end face comprising a working surface configured for contact with the capacitive touch screen while writing or drawing;
an elongate barrel configured for gripping by a user and having a central longitudinal axis and a first end secured to the rigid stylus tip; and
at least an end portion of the stylus tip being oriented at a predetermined offset angle relative to the barrel, such that the end face is not perpendicular to the central longitudinal axis of the barrel.

2. The device of claim 1, wherein the barrel and tip are formed integrally in one piece.

3. The device of claim 1, wherein the stylus tip has a connector portion configured for releasable, coaxial connection to the first end of the barrel, and the end portion of the tip is oriented at the offset angle to the connector portion.

4. The device of claim 1, wherein the offset angle is between 1 degree and 30 degrees.

5. The device of claim 4, wherein the offset angle is between 15 and 25 degrees.

6. The device of claim 1, wherein the working surface is not flat.

7. The device of claim 6, wherein the working surface is of part-spheroidal shape.

8. The device of claim 6, wherein the working surface has a cross-sectional shape selected from the group consisting of part of a circle, a parabola, and an ellipse.

9. The device of claim 6, wherein the working surface has a cross-sectional shape having a predetermined interface radius and a predetermined chord length, and the ratio of the interface chord length to the interface radius is no more than two.

10. The device of claim 1, wherein the working surface has a surface area in the range of about 0.012 to 0.070 inches squared.

11. The device of claim 1, wherein the tip has an undercut immediately behind the working surface.

12. The device of claim 11, wherein the tip tapers inwardly from the working surface towards the barrel.

13. The device of claim 12, wherein barrel and tip are formed integrally and the tip has a neck portion of smaller diameter than the remainder of the tip adjacent the first end of the barrel.

14. The device of claim 1, wherein the working surface has a peripheral edge and the tip has a blend radius extending to the peripheral edge of the working surface.

15. The device of claim 1, wherein at least the tip is made of a non-compressible, conductive material selected from the group consisting of metal, impregnated plastics, resins, ceramics, or compacted fiber material.

16. The device of claim 1, wherein the tip is made of a non-compressible and non-conductive material coated with a conductive or semi-conductive material.

17. The device of claim 1, wherein the barrel is of the same material as the tip.
